(19) United States
(12) Patent Application Publication
(10) Pub. No.: US 2007/0074414 A1
(43) Pub. Date: Apr. 5, 2007

(54) DIGITAL SPEED SQUARE APPARATUS AND METHOD FOR USING THE SAME

(76) Inventor: BRAD J. NEUROTH, NAMPA, ID (US)

Correspondence Address: DYKAS, SHAVER & NIPPER, LLP, P.O. BOX 877, BOISE, ID, 83701-0877, US

(21) Appl. No.: 11/382,344

(22) Filed: May 9, 2006

Related U.S. Application Data
(63) Continuation-in-part of application No. 11/243,877, filed on Oct. 4, 2005.

(51) Int. Cl. B43L 7/00

(52) U.S. Cl. 33/429

(57) ABSTRACT

A combination speed square with integral measuring device for allowing a construction framer to quickly and easily layout wall stud locations, floor joist locations, floor truss locations and other layouts.

### PRIORITY

This application is a Continuation-in-Part patent application of application Ser. No. 11/243,877, filed on Oct. 4, 2005, having the same inventor and title, the disclosure of which is incorporated herein by reference.

### BACKGROUND OF THE INVENTION

1. Field of the Invention

The present invention generally relates to construction tools, and more particularly relates to speed squares further configured for measuring distances.

2. Background Information

A speed square is a generally triangular piece of material (typically metal or plastic) that is used to determine and mark the correct base and common cut marks for rafters. Speed squares are used for rafter layouts by construction framers; however a speed square is also a “square,” meaning that it has a generally perpendicular measuring edge which is frequently used by framers to draw straight lines upon pieces of dimensional lumber thereby marking the placement of wall studs, cuts, and the like.

U.S. Pat. No. 5,170,568 to Wright notes that speed squares “enable the roofing carpenter to mark and cut the base cut of a rafter. The rafter base cut is a horizontal cut at the bottom extreme of the rafter. The angle between the base cut and longitudinal axis of the rafter is a function of the slope of the roof. The speed square currently enjoying the greatest usage by roofing carpenters in this country is Swanson's Marking Tool with Wear Rims (U.S. Pat. No. 4,742,619). Swanson's Marking Tool features a scale parallel to the tool hypotenuse which incorporates roof unit rise values typically ranging from one inch roof risers per foot roof run to 30 inches roof rise per foot roof run. This scale is used to mark the base cut angle of rafters. Roofing carpenters are [also] frequently required to make rafter common cut marks while perched atop of the roof under construction.”

Cottongim, et al., (U.S. Pat. No. 5,575,074) further reminds us that “roof framers and many other trades typically make daily use of triangular shaped framing squares known as speed squares,” and that the “primary reason for the popularity of speed squares is that they are small and lightweight making them suitable for replacing bulky framing squares and T-squares. A very common use for speed squares is to square scribe building materials such as lumber, roofing, and the like.”

One such “square scribe” use of such a speed square is in the layout of a building's wall. In such an instance, a framer will lay out a piece of dimensional lumber that would serve as the base plate for the wall. The framer then uses a tape measure and a writing utensil (pen, pencil) to mark the appropriate stud locations for the wall. For instance, placing regular marks on the piece of dimensional lumber representing a sixteen (16) inch “on center” stud arrangement. After marking all of the “on center” locations, the framer will then come back to the marks and use a speed square to draw straight lines.

What is needed is a novel combination of a speed square and a measuring device for simplifying the framer's job in laying out walls and other components within the building. By combining the measuring ability of a measuring device into a speed square, much time and effort could be conserved. Further, by marking the line the first time (instead of coming back later to create the formal mark) accuracy is increased.

### SUMMARY OF THE INVENTION

One embodiment of the present invention is a measuring speed square. This measuring speed square having a right-triangular member, a distance measuring device, a counter device, and a digital display. The right triangular member having a base edge, this base edge having at least one perpendicular flange along its length. In the preferred embodiment, the base edge having two perpendicular flanges thereby creating a generally T-shaped cross section for the right triangular member. The right triangular member further has a measurement edge and a hypotenuse edge. It is preferred that the intersection of the perpendicular flange and the right triangular members define a first inside corner and a second inside corner.

The distance measuring device is preferably located on either the perpendicular flange or the right triangular member. In the most preferred embodiment, the distance measuring device is incorporated within the perpendicular flange itself. This distance measuring device located adjacent to the inside corner so that when an outside corner of a piece of dimensional lumber is inserted into the inside corner, the distance measuring device can measure a distance that the speed square is slid along the piece of dimensional lumber. The distance measuring device thereby configured for measuring the distance, the speed square is slid along the outside corner of the piece of dimensional lumber inserted into said inside corner.

The counter device is in communication with the distance measuring device. That being said, the distance measured by the distance measuring device is counted by the counter device. The counter device is programmed thus, to count sequentially for a predetermined distance measured by the distance measuring device.

The digital display is located on the right triangular member. This digital display in communication with the counter device visually displaying an output of the counter device and thus, the distance measured by the distance measuring device. Optionally, rather than a digital display or in conjunction with a digital display, the device could be provided with another counter output, including, but not limited to light and/or sound.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other uses and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 shows a plan view of one embodiment of the present invention.

FIG. 2 shows an environmental end view of the second embodiment of the present invention.

FIG. 3 shows a plan view of a second embodiment of the present invention.

FIG. 4 showing a partial, perspective view of the embodiment of FIG. 3.

FIG. 5 showing a partial, perspective view of the embodiment of FIG. 3.

FIG. 6 showing a partial, plan view of the digital display apparatus of the embodiment of FIG. 3.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

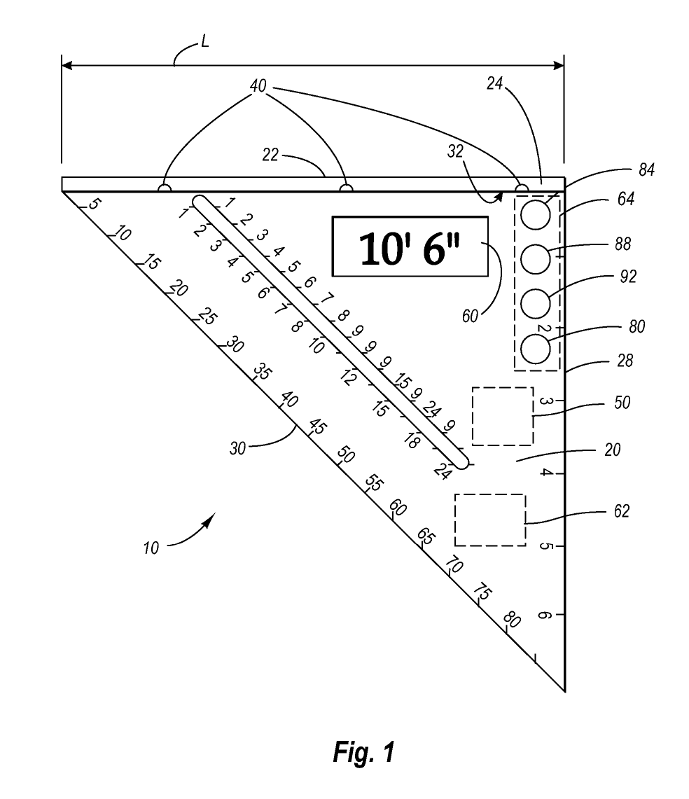

The present invention is an improved speed square that includes a measuring device. Referring initially to FIG. 1, shown is one embodiment of the present invention. In that figure, shown is a speed square 10. Such a speed square traditionally comprising a right triangular member 20 having base edge 22, a measurement edge 28 and a hypotenuse edge 30. The measurement edge 28 traditionally is also the square edge for drawing straight lines, as is well known in the prior art. Such a speed square traditionally has a plurality of hip-val top cuts and hip-val common cuts denoted thereon adjacent the hypotenuse edge 30.

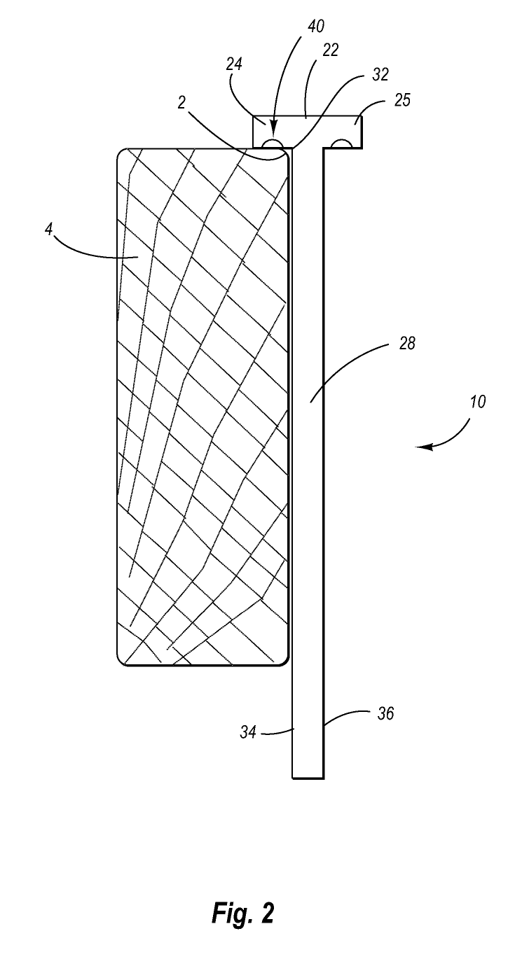

A related embodiment is shown in FIG. 2. That figure showing an end and/or cross sectional view of an embodiment of the present invention. In this embodiment, the base edge 22 has a first perpendicular flange 24 extending therefrom as well as a second perpendicular flange 25. These flanges working in conjunction with the body (right triangular member) 20 to create a generally T-shaped speed square. While this is the preferred configuration, the present invention could be provided with just one perpendicular flange thereby creating an inverted L-shaped speed square.

The intersection between the perpendicular flange(s) and the body of the right triangular member thereby creating at least one inside corner 32. The right triangular member having a first side 34 and a second side 36. This inside corner 32 configured for receiving therein the outside corner 2 of a piece of dimensional lumber 4 (as shown in FIG. 2). In such an arrangement, the speed square 10 is configured for sliding along the dimensional lumber 4 with the outside corner 2 generally inserted into the inside corner 32.

At least one distance measuring device 40 is located, preferably, on either the perpendicular flange or the right triangular member generally adjacent to the inside corner 32. In the embodiment shown in FIGS. 1 and 2, this location is the perpendicular flange 24. In the embodiment shown in FIG. 1, a plurality of distance measuring devices is spaced along the length (L) of the base edge 22.

The distance measuring device(s) 40 could be any suitable manner of measuring distance, including, but not limited to wheels, balls, optical devices, lasers, sonar, etc. Whatever the structure, the distance measuring device is configured for determining the distance speed square 10 has moved (slid/rolled/moved/etc) along a surface of a piece of dimensional lumber or other material.

In one embodiment of the present invention, the distance measuring device comprises at least one sensor configured for measuring the distance traveled by the speed square 10 along the surface to be measured. Preferably, this sensor comprises a light source that is shined upon the surface to be measured. An additional sensor within the distance measuring device then observes the reflection of the light off the surface to be measured and determines the distance that has been traveled. Such styles of a distance measuring devices are common within the prior art and such disclosure is intended to include such configurations, structures and types. An example of one such type of an optical measuring device is an optical computer mouse, which uses such technology to determine the movement of the mouse in relation to a mouse pad or other surface.

In another embodiment of the present invention, the distance measuring device comprises at least one wheel mounted on an axle (or otherwise mounted) that is able to roll along the surface to be measured. A rolling ball-type distance measuring device could likewise be utilized.

The speed square 10 further including at least one counter device 50 that works in cooperation with the distance measuring device 40. This counter device 50 connected to the distance measuring device(s) 40 and programmed to count sequentially for a predetermined distance measured by the distance measuring device(s) 40. Multiple counter devices could be provided if desired.

It is preferred that the counter device 50 be provided with a digital display 60 located upon the right triangular member and conveniently visually viewable by a user. The digital display 60 for providing a display of the output from the counter device, which is interconnected to the distance measuring device. Thereby, the digital display would display visually the output of the counter device(s) and thus the distance measured by the distance measuring device(s). Examples of digital displays include, but are not limited to LCD graphic modules, custom glass screen displays, mechanical counter dials, digital readouts, etc.

One example of a digital display 60 can be found in FIG. 1, wherein shown is one example of the possible display elements that could be included in such a display. In this example, the digital display is simple, merely showing a graphical representation of feet and inches.

While it is preferred that a digital display 60 be incorporated within the device 10, it is also likewise possible that various other types of counter outputs 62 could be used in conjunction with the digital display or instead of a digital display. For instance, a speaker or other audible communication device could be provided for emitting an audible sound, so that rather than (or in conjunction therewith) a digital display, a sound is created at appropriate intervals and/or measurements. In one example, as the speed square 10 is slid along the surface that is to be measured and marked, a “beep” sound could be produced every sixteen (16) inches or other desired measurement (19.2 inches, twenty-four inches, etc). Likewise, a flash of light or other type of visual display could be provided for indicating to the user that a predetermined distance had been traversed. Again, while it is preferred that a “digital” display be provided, an analog or other mechanical display could likewise be used. Of course, these two representative “displays” are not intended in any way as being the exclusive displays and display elements.

In conjunction with the counter device 50, it is preferred that a counter control apparatus 64 for controlling the output from an operation of the counter device 50 be provided. One possible component in such a counter control apparatus 64 is a reset 84. Such a reset 84 (in this case a button) could be provided for resetting the counter device 50 back to zero or another predetermined position. For instance, when starting a new measurement, a user may need to “zero” the speed square's counter device for purposes of making the appropriate measurement. The reset 84 (or another button) could also serve as the ON/OFF switch too.

Another possible component of the counter control apparatus 64 would be a centering device/setting 88. The centering device is for helping a user determine the center of a measurement (for instance the center of a door or window location or two other measurements). For instance, the user could zero the square, slide the square a distance, press a “centering button,” the counter control apparatus 64 would then determine the center measurement, the user would then be able to slide the square back towards the “zero” location until the display or other counter output indicates that the “center” has been reached. At such a point the user would be able to make a mark on the surface measured thereby indicating the center of the measurement.

Another possible component of the counter control apparatus would be a layout device 80 (in this case a button). Various layouts could be custom entered or pre-programmed. For instance, a “sixteen-inch-on-center” layout could be selected whereby the device could be zeroed and set to “beep” at every sixteen inches measured. The layout button allowing layout functionality to be turned ON or OFF. In the preferred embodiment, depressing the button would scroll between a choice of a number of different layouts. Preferably when the layout device is turned off, it will remember the last layout used and will resume with that layout when such functionality is turned back on.

Yet another possible component of the counter control apparatus would be a memory device 92 (in this case a button). Such a component for allowing a user to “pause” or “freeze” measuring when laying out a layout. For instance, when a user is laying out floor joists and/or floor trusses and the user wants to continue making a lateral layout taking into consideration bump-outs, jogs, rooms and other deviations off a straight line in a layout, the user could, when he reached the end of line, press a memory button thereby “pausing” measurement. The user would then move to the next parallel location on the layout and be able to continue laying out the floor joist/truss locations (after pressing the “memory” button (or other manner of reinitiating the measuring process)).

The powered components of the present invention (if present) would be powered by a power source. Example power sources include, but are not limited to one or more batteries, one or more solar cells, alternating current (AC), direct current (DC), kinetic motion, etc.

As such, there are countless ways of powering the present invention. Listed here is a list of some, but not all of such ways. First, the solar cells could be utilized as a charging system for the batteries, whereby the device would operate primarily on the batteries and the solar cells helping to increase the duration between replacing and/or recharging the batteries. Second, the device could be run mainly from the solar cells, with the battery serving as a backup system when low ambient light levels are present. Third, the device could be run strictly from rechargeable batteries with a recharging system (integral and/or removable batteries) would then be used to recharge the batteries. Fourth, the device could run from solar cells only, thereby reducing the cost and weight of the device. Again, as mentioned above, these four examples are not intended as being the exclusive manners of powering the speed square 10.

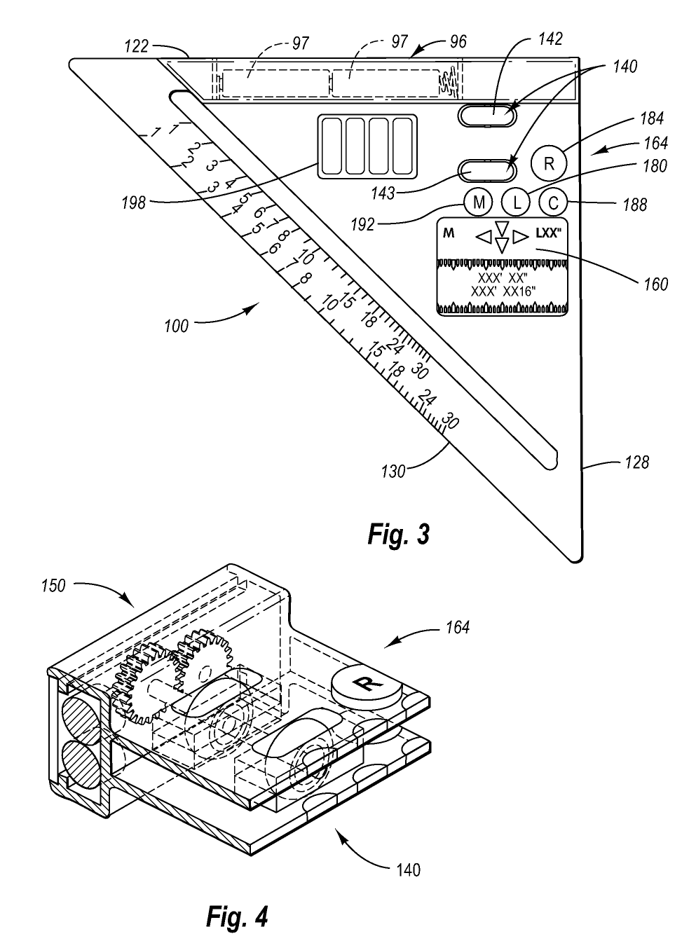

A second embodiment of the present invention is shown in FIGS. 3-6. These figures showing an improved speed square 110 that includes a measuring device. Such a speed square 110 traditionally comprising a right triangular member 120 having base edge 122, a measurement edge 128 and a hypotenuse edge 130. The measurement edge 128 traditionally is also the square edge for drawing straight lines, as is well known in the prior art. Such a speed square traditionally has a plurality of hip-val top cuts and hip-val common cuts denoted thereon adjacent the hypotenuse edge 130.

In the embodiment shown in FIGS. 3-5, the distance measuring device 140 comprising a pair of roller wheels (142, 143) connected via an axle 145 to at least one gear 146. This gear for cooperating with the counter device 150 (described infra). The preferred roller wheel (142, 143) is plastic over molded with rubber, however other wheel constructions are also available. Use of a pair (or more) of wheels is preferred (although not mandatory) for accuracy (less likely that both wheels will slip or be otherwise interfered with.

The distance measuring device(s) 140 could be any suitable manner of measuring distance, including, but not limited to wheels, balls, optical devices, lasers, sonar, etc. Whatever the structure, the distance measuring device is configured for determining the distance speed square 110 has moved (slid/rolled/moved/etc) along a surface of a piece of dimensional lumber or other material.

In one embodiment of the present invention, the distance measuring device comprises at least one sensor configured for measuring the distance traveled by the speed square 110 along the surface to be measured. Preferably, this sensor comprises a light source that is shined upon the surface to be measured. An additional sensor within the distance measuring device then observes the reflection of the light off the surface to be measured and determines the distance that has been traveled. Such styles of a distance measuring devices are common within the prior art and such disclosure is intended to include such configurations, structures and types. An example of one such type of an optical measuring device is an optical computer mouse, which uses such technology to determine the movement of the mouse in relation to a mouse pad or other surface.

In another embodiment of the present invention, the distance measuring device comprises at least one wheel mounted on an axle (or otherwise mounted) that is able to roll along the surface to be measured. A rolling ball-type distance measuring device could likewise be utilized.

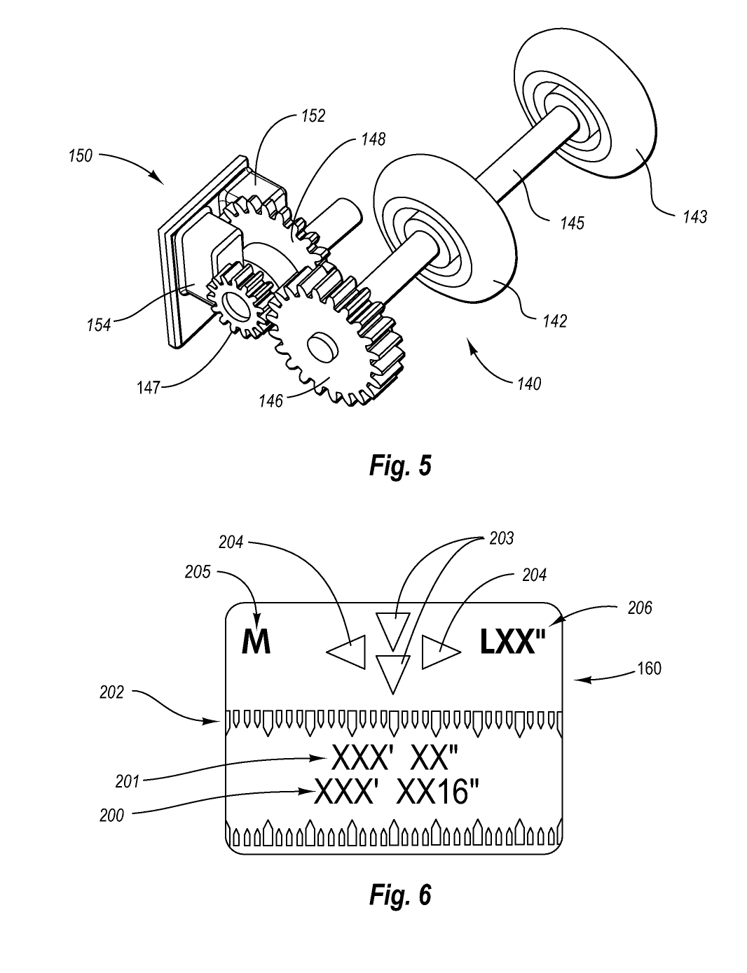

The speed square 110 further including at least one counter device 150 (particularly shown in FIGS. 4 and 5) that works in cooperation with the distance measuring device 140. This counter device 150 connected to the distance measuring device(s) 140 and programmed to count sequentially for a predetermined distance measured by the distance measuring device(s) 140. Multiple counter devices could be provided if desired.

The distance measuring device 140 having an axle 145 terminating in a gear 146. This gear for turning a mating gear 147. Gears are preferred for the purpose of maintaining accuracy. This mating gear 147 serving as or connecting thereto an encoder wheel 148. This encoder wheel 148 for cooperating with the counter device 50. In this embodiment, the counter device 50 comprising an LED light (unit) 152, a photodiode (unit) 154 and the encoder wheel 148. The LED light 152 and photodiode 154 opposite one another with the encoder wheel 148 passing therethrough. As the encoder wheel 148 passes in-between them, the light (from the LED) to the photodiode is intermittently broken. The counter device 50 (or a computer therein) then counting the number of flashes the photodiode “sees.” The number of flashes allowing the distance traveled to thusly be calculated.

It is preferred that the counter device 150 be provided with a digital display 160 located upon the right triangular member and conveniently visually viewable by a user. The digital display 160 for providing a display of the output from the counter device that is interconnected to the distance measuring device. Thereby, the digital display would display visually the output of the counter device(s) and thus the distance measured by the distance measuring device(s). Examples of digital displays include, but are not limited to LCD graphic modules, custom glass screen displays, mechanical counter dials, digital readouts, etc.

FIGS. 3 and 6 showing an additional example of a digital display 160. The display 160 having an “inch and fraction inch” marker 200 for displaying the current inch/fraction of an inch. The display 160 having a “foot and inch” marker 201 for displaying traditional “foot and inch” style measurements. Additional marks/colors may be provided at standard measurements, for instance red letters at sixteen (16) inch increments and black diamonds at 19.2 inch increments. Sixteenth marks 202 would likely be provided at 1/16 of an inch increments. Standard layout arrows 203 for denoting when a standard layout (sixteen inches, 19.2 inches, twenty-four inches, etc.) is reached could also be provided. Center direction arrows 204 could be provided for the direction the device needs to be moved to arrive at the center. A memory indicator 205 would be provided for denoting that the memory function is working. If the user were to try and roll the present invention without first clearing the memory, in this embodiment, the measurements would not move. Finally, layout indicators 206 may also be provided for stating what layout has been activated, for instance “L16” representing “layout 16 inch on center,” etc. Note, while the present invention is discussed using imperial units (inches, feet, etc.), nothing is intended in limiting its use (when so configured) in metric applications.

While it is preferred that a digital display 160 be incorporated within the device 110, it is also likewise possible that various other types of counter outputs 162 could be used in conjunction with the digital display or instead of a digital display. For instance, a speaker or other audible communication device could be provided for emitting an audible sound, so that rather than (or in conjunction therewith) a digital display, a sound is created at appropriate intervals and/or measurements. In one example, as the speed square 110 is slid along the surface that is to be measured and marked, a “beep” sound could be produced every sixteen (16) inches or other desired measurement (19.2 inches, twenty-four inches, etc). Likewise, a flash of light or other type of visual display could be provided for indicating to the user that a predetermined distance had been traversed. Again, while it is preferred that a “digital” display be provided, an analog or other mechanical display could likewise be used. Of course, these two representative “displays” are not intended in any way as being the exclusive displays and display elements.

In conjunction with the counter device 150, it is preferred that a counter control apparatus 164 for controlling the output from an operation of the counter device 150 be provided. The preferred counter control apparatus 150 (as shown in FIG. 3) is a tactile membrane switch having an overlay configured for cooperating with a plurality of snap domes thereby allowing a user to make connections on a printed circuit board. Other types of counter control apparatuses are likewise envisioned.

One possible component in such a counter control apparatus 164 is a reset 184. Such a reset 184 (in this case a button) could be provided for resetting the counter device 150 back to zero or another predetermined position. For instance, when starting a new measurement, a user may need to “zero” the speed square's counter device for purposes of making the appropriate measurement. The reset 184 (or another button) could also serve as the ON/OFF switch too.

Another possible component of the counter control apparatus 164 would be a centering device/setting 188. The centering device is for helping a user determine the center of a measurement (for instance the center of a door or window location or two other measurements). For instance, the user could zero the square, slide the square a distance, press a “centering button,” the counter control apparatus 164 would then determine the center measurement, the user would then be able to slide the square back towards the “zero” location until the display or other counter output indicates that the “center” has been reached. At such a point the user would be able to make a mark on the surface measured thereby indicating the center of the measurement.

Another possible component of the counter control apparatus would be a layout device 180 (in this case a button). Various layouts could be custom entered or pre-programmed. For instance, a “sixteen-inch-on-center” layout could be selected whereby the device could be zeroed and set to “beep” at every sixteen inches measured. The layout button allowing layout functionality to be turned ON or OFF. In the preferred embodiment, depressing the button would scroll between a choice of a number of different layouts. Preferably when the layout device is turned off, it will remember the last layout used and will resume with that layout when such functionality is turned back on.

Yet another possible component of the counter control apparatus 164 would be a memory device 192 (in this case a button). Such a component for allowing a user to “pause” or “freeze” measuring when laying out a layout. For instance, when a user is laying out floor joists and/or floor trusses and the user wants to continue making a lateral layout taking into consideration bump-outs, jogs, rooms and other deviations off a straight line in a layout, the user could, when he reached the end of line, press a memory button thereby “pausing” measurement. The user would then move to the next parallel location on the layout and be able to continue laying out the floor joist/truss locations (after pressing the “memory” button (or other manner of reinitiating the measuring process)).

The powered components of the present invention (if present) would be powered by a power source 196. Example power sources include, but are not limited to one or more batteries 197, one or more solar cells 198, alternating current (AC), direct current (DC), kinetic motion, etc.

As such, there are countless ways of powering the present invention. Listed here is a list of some, but not all of such ways. First, the solar cells could be utilized as a charging system for the batteries, whereby the device would operate primarily on the batteries and the solar cells helping to increase the duration between replacing/recharging the batteries. Second, the device could be run mainly from the solar cells, with the battery serving as a backup system when low ambient light levels are present. Third, the device could be run strictly from rechargeable batteries with a recharging system (integral and/or removable batteries) would then be used to recharge the batteries. Fourth, the device could run from solar cells only, thereby reducing the cost and weight of the device. Again, as mentioned above, these four examples are not intended as being the exclusive manners of powering the speed square.

There are a number of embodiments of the present invention, some of which are discussed infra.

### EXAMPLE A

In this example, the speed square comprises a right-triangular member, a distance measuring device, a counter device, and a counter output. The right triangular member having a base edge having at least one perpendicular flange along its length. The right triangular member having a measurement edge and a hypotenuse edge. The perpendicular flange and the right-triangular member defining an inside corner.

The distance measuring device is preferably located on the perpendicular flange and/or the right-triangular member. The distance measuring device is preferably located adjacent to the inside corner. The distance measuring device configured for measuring the distance the speed square is slid along an outside corner of a piece of dimensional lumber inserted into the inside corner.

The counter device in communication with the distance measuring device. The said counter device preprogrammed to count sequentially for a predetermined distance measured by the distance measuring device. The counter output, preferably a digital display, located on the right-triangular member. The counter output in communication with the counter device for visually displaying an output of the counter device and thus the distance measured by the distance measuring device.

Preferably, the right-triangular member has a first side opposite a second side and the counter output is a digital display located on the first side and the inside corner is adjacent the second side. Optionally, the counter output of the speed square could comprise a digital display on each side of the right-triangular member. Optionally, the right-triangular member has a first side opposite a second side, and the base edge has two perpendicular flanges along its length (a first flange perpendicularly extending from the first side and a second flange perpendicularly extending from the second side), this configuration resulting in a speed square of generally a T-shaped cross section.

Optionally, the speed square comprises a counter output and at least one distance measuring device on each side of the right-triangular member. Optionally, the distance measuring device comprises a protruding roller configured for rollably traversing the surface to be measured. Optionally, the distance measuring device comprises a sensor configured for measuring the distanced traveled by the speed square along a surface to be measured. In one embodiment, this sensor comprises a light source.

Optionally, a sound emitting device in communication with the counter device for emitting a sound at a predetermined distance measured by the distance measuring device could be provided, and the predetermined distance could be changed through use of a layout device. Optionally, the counter device could further comprise a reset device for resetting the counter to a predetermined number and/or a centering device for determining the center of a distance measured by the speed square and indicating that center distance to a user of the speed square. Further, optionally, the counter device could comprise a memory device for allowing the speed square to pause the counting by the counting device. Optionally, the speed square could comprise a light emitting device (LED) or other visual display in communication with the counter device for emitting a light display at a predetermined distance measured by the distance measuring device.

### EXAMPLE B

In this example, the speed square comprises a right-triangular member, a distance measuring device, a counter device, a digital display, and a sound emitting device. The right-triangular member having a base edge, this base edge having at least one perpendicular flange along its length. The right-triangular member further having a measurement edge and a hypotenuse edge. The right-triangular member having a first side opposite a second side. The perpendicular flange and the right-triangular member defining an inside corner.

The distance measuring device located on either the perpendicular flange (preferred) or the right-triangular member. The distance measuring device adjacent to the inside corner. The distance measuring device configured for measuring the distance the speed square is slid along an outside corner of a piece of dimensional lumber inserted into the inside corner. In communication with the distance measuring device is the counter device. The counter device preprogrammed to count sequentially for a predetermined distance measured by the distance measuring device. This connection preferably being electrical.

The digital display located on the right-triangular member and in communication with the counter device for visually displaying an output of the counter device, and thus the distance measured by the distance measuring device. The sound emitting device in communication with the counter device for emitting a sound at predetermined distance measured by the distance measuring device.

Optionally, the distance measuring device could comprise a protruding roller configured for rollably traversing the surface to be measured. Another option would be that the distance measuring device would comprise a sensor configured for measuring the distanced traveled by the speed square along a surface to be measured.

Optionally, the counter device could further comprise a reset device for resetting the counter to a predetermined number; a centering device for determining the center of a distance measured by the speed square and indicating that center distance to a user of the speed square; and/or a memory device for allowing the speed square to pause the counting by the counting device.

### EXAMPLE C

The present invention could further comprise a method of use for a speed square whereby wall layouts can be quickly created. In such a method, the roofing speed square comprising: a right-triangular member, a distance measuring device, a counter device and a digital display. The right triangular member having a base edge having at least one perpendicular flange along its length. The right triangular member having a measurement edge and a hypotenuse edge. The perpendicular flange and the right-triangular member defining an inside corner.

The distance measuring device located on either the perpendicular flange or the right-triangular member. The distance measuring device adjacent to the inside corner. The distance measuring device configured for measuring the distance the speed square is slid along an outside corner of a piece of dimensional lumber inserted into the inside corner.

The counter device in communication with the distance measuring device. The counter device preprogrammed to count sequentially for a predetermined distance measured by the distance measuring device.

The digital display located on the right-triangular member. The digital display in communication with the counter device for visually displaying an output of the counter device and thus, the distance measured by the distance measuring device.

The method of use for the speed square whereby wall layouts can be quickly created may be made comprising the following steps: (a) providing a piece of dimensional lumber to be marked, the piece of dimensional lumber having an outside corner, an end and a length; (b) positioning the outside corner within the inside corner; (c) aligning the measurement edge of the speed square with the piece of dimensional lumber end; (d) sliding the speed square along the length; (e) stopping the sliding process when the counter reaches a predetermined measurement; and (f) making a mark upon the piece of dimensional level adjacent the measurement edge representing the predetermined measurement.

There are a number of different ways of using the preferred embodiment of the present invention, including measuring mode, centering mode, layout mode and memory mode. The examples provided herein are illustrative in nature of possible embodiments of the present invention and are not intended as being limitations to every embodiment of the present invention.

In measuring mode, this is the most basic function of the present invention. The speed square is used to simply measure a distance along a straight flat surface. Example steps for using this embodiment including: (1) activating the speed square by pressing the reset button; (2) placing the speed square onto a flat surface, with the roller (distance measuring device) touching the surface to be measured; (3) if the speed square has a measurement reading other that 0″, repress the reset button to zero the speed square before measuring; (4) rolling the speed square in a steady smooth motion keeping it flat against the material; and (5) when the desired distance is reached, place a mark along the edge of the measurement edge of the speed square and either continue to the next measurement, or reset to zero.

In centering mode, the center function is used to quickly and easily find the center between any two distances. This is extremely helpful when trying to layout features such as doors, window, or partitions in wall layouts. Steps for using (this embodiment of) the centering mode are: (1) activating the speed square by pressing the reset button; (2) placing the speed square at beginning of an opening; (3) zeroing the speed square by pressing the reset button; (4) activating the center function by pressing the centering device/button; (5) sliding the speed square to the desired opening width; (6) pressing the center button again to mark opening width; (7) sliding the speed square in the reverse direction until the screen flashes; and (8) when the desired distance is reached, place a mark along the edge of the measurement edge of the speed square to signify the center of the opening. Deactivation of the centering function could be had by simply pressing and holding the center button for a couple seconds.

In layout mode, the layout function is used to simplify layout of typical stud, joist, and rafter distances. The standard distances used by the layout function are 16″, 19.2″, and 24″. Example steps for use in this mode include: (1) choosing the layout distance by pressing the layout button until the distance desired appears in upper right hand portion of the screen; (2) place the speed square at the desired starting point; (3) zero measurement by pressing the reset button; (4) slide the speed square until screen flashes on first desired distance; (5) mark distance by placing a mark along the edge of the measurement edge of the speed square; (6) continue to slide until next mark is reached (screen flashes again); (7) mark distance by placing a mark along the edge of the measurement edge of the speed square; (8) continue cycle (steps 7 and 8) until layout is complete; and (9) to exit layout function press and hold layout button for a couple of seconds. It is preferred that the layout function remember last layout used, such that the next time the function is activated, it will start at the previous layout distance.

In memory mode, the memory function is used to assist the layout function when it is necessary to pick up and move the speed square (i.e. dealing with a jog in a wall). Example steps for use include: (1) while in layout mode, stop the speed square at a desired ending position (if dealing with a jog in a wall layout, the desired ending position would best be the inside edge of the perpendicular wall such that when the speed square is picked up and replaced at the end of the jog, it will be easy to place the edge of the device on the same edge as it ended on); (2) press the memory button to freeze the measurement; (3) move the speed square to the desired starting position; (4) press the memory button again to reactivate the layout function and continue sliding the speed square along the surface.

While herein is shown and described the present preferred embodiments of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A speed square comprising:
a right-triangular member, said right triangular member having a base edge, said base edge having at least one perpendicular flange along its length, a measurement edge and a hypotenuse edge, said perpendicular flange and said right-triangular member defining an inside corner;
a distance measuring device located on either said perpendicular flange or said right-triangular member, said distance measuring device configured for measuring the distance said speed square is slid along an outside corner of a piece of dimensional lumber inserted into said inside corner;
a counter device in communication with said distance measuring device, said counter device preprogrammed to count sequentially for a predetermined distance measured by said distance measuring device; and
a counter output on said right-triangular member, said counter output in communication with said counter device for outputting to a user an output of said counter device and thus the distance measured by said distance measuring device.

2. The speed square of claim 1, wherein said right-triangular member has a first side opposite a second side.

3. The speed square of claim 2, wherein said counter output is a digital display located on said first side and said inside corner is adjacent said second side.

4. The speed square of claim 2, wherein said counter output of said speed square comprises a digital display on each side of said right-triangular member.

5. The speed square of claim 1, wherein said right-triangular member has a first side opposite a second side, and said base edge has two perpendicular flanges along its length, a first flange perpendicularly extending from said first side and a second flange perpendicularly extending from said second side, said configuration resulting a speed square of T-shaped cross section.

6. The speed square of claim 5, wherein said speed square comprises a counter output and distance measuring device on each side of said right-triangular member.

7. The speed square of claim 1, wherein said distance measuring device comprises at least one protruding roller configured for rollably traversing the surface to be measured.

8. The speed square of claim 7, wherein said counter device comprises a LED and a photodiode, said LED and photodiode having disposed there-between an encoder wheel in communication with said distance measuring device, wherein rotation of the at least one protruding roller causes the encoder wheel to rotate between the LED and photodiode thereby allowing distance to be measured.

9. The speed square of claim 1, wherein said distance measuring device comprises a sensor configured for measuring the distanced traveled by the speed square along a surface to be measured.

10. The speed square of claim 1, further comprising a power source.

11. The speed square of claim 1, further comprising a sound emitting device in communication with said counter device for emitting a sound at predetermined distance measured by said distance measuring device.

12. The speed square of claim 11, wherein said predetermined distance is changed through use of a layout device.

13. The speed square of claim 1, wherein said counter device further comprises a reset device for resetting said counter to a predetermined number.

14. The speed square of claim 1, wherein said counter device further comprises a centering device for determining the center of a distance measured by said speed square and indicating that center distance to a user of said speed square.

15. The speed square of claim 1, wherein said counter device further comprises a memory device for allowing the speed square to pause the counting by said counting device.

16. A speed square comprising:
a right-triangular member, said right triangular member having a base edge, said base edge having at least one perpendicular flange along its length, a measurement edge and a hypotenuse edge, said right-triangular member having a first side opposite a second side, said perpendicular flange and said right-triangular member defining an inside corner;
a distance measuring device located on either said perpendicular flange or said right-triangular member, said distance measuring device configured for measuring the distance said speed square is slid along an outside corner of a piece of dimensional lumber inserted into said inside corner;
a counter device in communication with said distance measuring device, said counter device preprogrammed to count sequentially for a predetermined distance measured by said distance measuring device;
a digital display on said right-triangular member, said digital display in communication with said counter device for visually displaying an output of said counter device and thus the distance measured by said distance measuring device; and
a sound emitting device in communication with said counter device for emitting a sound at predetermined distance measured by said distance measuring device.

17. The speed square of claim 16, wherein said distance measuring device comprises at least one protruding roller configured for rollably traversing the surface to be measured.

18. The speed square of claim 16, wherein said distance measuring device comprises a sensor configured for measuring the distanced traveled by the speed square along a surface to be measured.

19. The speed square of claim 16, wherein said counter device further comprises:
a reset device for resetting said counter to a predetermined number;
a centering device for determining the center of a distance measured by said speed square and indicating that center distance to a user of said speed square; and
a memory device for allowing the speed square to pause the counting by said counting device.

20. A method of use for a speed square whereby wall layouts can be quickly created, said roofing speed square comprising:
a right-triangular member, said right triangular member having a base edge, said base edge having at least one perpendicular flange along its length, a measurement edge and a hypotenuse edge, said perpendicular flange and said right-triangular member defining an inside corner;
a distance measuring device located on either said perpendicular flange or said right-triangular member, said distance measuring device configured for measuring the distance said speed square is slid along an outside corner of a piece of dimensional lumber inserted into said inside corner;
a counter device in communication with said distance measuring device, said counter device preprogrammed to count sequentially for a predetermined distance measured by said distance measuring device; and
a digital display on said right-triangular member, said digital display in communication with said counter device for visually displaying an output of said counter device and thus the distance measured by said distance measuring device;
the method of use for said speed square whereby wall layouts can be quickly created may be made comprising the following steps:
(a) providing a piece of dimensional lumber to be marked, said piece of dimensional lumber having an outside corner, an end and a length;
(b) positioning said outside corner within said inside corner;
(c) aligning the measurement edge of said speed square with said piece of dimensional lumber end;
(d) sliding said speed square along said length;
(e) stopping said sliding process when said counter reaches a predetermined measurement; and
(f) making a mark upon said piece of dimensional level adjacent said measurement edge representing said predetermined measurement.
